(19) United States
(12) Patent Application Publication
(10) Pub. No.: US 2026/0101351 A1
(43) Pub. Date: Apr. 9, 2026

(54) METHODS, ARCHITECTURES, APPARATUSES AND SYSTEMS FOR PRECODER TYPE REPORTING

(71) Applicant: InterDigital Patent Holdings, Inc., Wilmington, DE (US)

(72) Inventors: Salah Elhoushy, LaSalle (CA); Patrick Svedman, Stockholm (SE); Afshin Haghighat, Ile-Bizard (CA); Allan Yingming Tsai, Boonton, NJ (US); Chia-Hung Wei, Chesterbrook, PA (US); Yifan Li, Conshohocken, PA (US); Ravikumar Pragada, Warrington, PA (US)

(21) Appl. No.: 18/906,615

(22) Filed: Oct. 4, 2024

(51) Int. Cl. H04W 72/23; H04L 5/00

(52) U.S. Cl. CPC H04W 72/23; H04L 5/0048

(57) ABSTRACT

For a wireless transmit-receive unit (WTRU) moving between near field and far field (NF/FF) regions of a cell, the planar wave approximation used in the FF region may not be adapted to the NF region. Therefore, the WTRU may determine a transmission precoder type of a set of transmission precoder types, and at least one downlink (DL) reference signal (RS). The WTRU may perform one or more measurements based on the DL RS. The WTRU may determine a transmission precoder type from the set of transmission precoder types based on the one or more measurements meeting the associated conditions. The WTRU may transmit a report to the network, the report comprising an indication of the determined transmission precoder type, to be used by the network for DL transmissions to the WTRU, for improved reception of these transmissions by the WTRU in the region where the WTRU is located.

### BACKGROUND

The present disclosure is generally directed to the fields of communications, software and encoding, including, for example, to methods, architectures, apparatuses, systems related to radio communications in wireless networks.

### SUMMARY

There are disclosed embodiments of methods, as described in the following and as claimed in the appended claims.

There are disclosed embodiments of a device, as described in the following and as claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 shows delay spread for WTRUs located at different locations in a cell; and

FIG. 3 is a flow chart of a method, implemented by a WTRU, for reporting precoder type according to an embodiment.

### DETAILED DESCRIPTION

### Abbreviations and Acronyms

CQI Channel Quality Index
CRI CSI-RS Resource Indicator
CSI Channel State Information
CSI-RS CSI-Reference Signal
DCI Downlink Control Information
DFT Discrete Fourier Transform
DL Downlink
DM Demodulation
DMRS DM Reference Signal
FF Far Field
ID Identifier
LI Layer Indicator
NF Near Field
MAC-CE MAC Control Element
PBCH Physical Broadcast Channel
PMI Precoding Matrix Index
PDCCH Physical DL Control Channel
PDSCH Physical DL Shared Channel
PRS Positioning RS
PUCCH Physical UL Control Channel
PUSCH Physical UL Shared Channel
RI Rank Indicator
RRC Radio Resource Control
RS Reference Signal(s)
RSRP Reference Signal Received Power
SINR Signal-to-Interference and Noise Ratio
SS Synchronization Signal
SSB SS Block
UE User Equipment (see WTRU)
UL Uplink
UPA Uniform Planar Array
WTRU Wireless Transmit-Receive Unit (see UE)

### Terminology, Principles and Observations

### [FF Beam]

An FF beam may correspond to a beam that focuses energy on a particular spatial direction. An FF beam may achieve the same beamforming gain, regardless of the distance between the transmitter and receiver, as long as the far-field approximation is applicable.

An FF beam may correspond to a real- or complex-valued matrix, e.g., a vector. An FF beam may also refer to a spatial domain basis vector (e.g., a spatial direction vector). An FF beam may refer to an FF basis beam.

A codebook of FF beams may refer to a two-dimensional grid of FF beams where each FF beam may be associated with a beam index. Also, each FF beam may be associated with two indices where the first index may indicate a horizontal beam index and the second index may indicate a vertical beam index.

An example of an FF beam is DFT beam. Also, a codebook of FF beams may refer to a codebook of DFT beams where a codebook of DFT beams may include one or more orthogonal DFT beams and one or more oversampled DFT beams. One or more orthogonal DFT beams may correspond to columns in a DFT matrix.

A codebook of FF beams may refer to a codebook of FF beams for constructing NF beams

A codebook of FF beams may refer to a codebook of FF beams for constructing a codebook of NF beams

A codebook of FF beams may refer to a codebook for constructing NF beams

Also, a codebook of FF beams may refer to a set of FF beams, e.g., a set of FF beams for constructing NF beams or a codebook of NF beams

Also, a codebook of FF beams may refer to a set of FF beams, e.g., a set of FF beams for constructing FF beams

An FF beam may correspond to a vector from a codebook of FF beams

An FF beam may correspond to a codeword from a codebook of FF beams

A codebook of FF beams may refer to a codebook of FF precoders

An FF beam may correspond to an FF precoder (e.g., rank-1 FF precoder in a codebook of FF precoders)

Selecting an FF beam may correspond to selecting:
an FF precoder;
a codeword in a configured codebook, e.g., codebook of FF beams, codebook of FF precoders;
a vector in a configured codebook, e.g., codebook of FF beams, codebook of FF precoders.

### [NF Beam]

An NF beam, or spot beam, may correspond to a beam that focuses energy on a particular spatial direction and distance from the antenna array, e.g., the focus distance. An NF beam may achieve the highest beamforming gain in the spot corresponding to the spatial direction and the distance.

An NF beam may correspond to a complex-valued vector, as an FF beam.

An NF beam may be constructed by multiplication, e.g., element-wise multiplication, of an FF beam that corresponds to the spatial direction and a phase correction factor (e.g., a vector of the same size as the FF beam) that represents the beamfocusing towards the distance corresponding to the NF beam. In some cases, a phase correction factor may be represented by a phase calculation function by which the elements of the phase correction factor may be computed. In one example, the function includes a parameter, for instance called beamfocusing parameter, the corresponds to the distance of the NF beam. For instance, with different beamfocusing parameters used to generate the phase correction factor, different focus distances may be achieved for the resulting NF beam.

### [Beamfocusing Parameter]

Beamfocusing parameter c refers to the parameter that the WTRU applies to construct the required phase correction vector b to be applied to an FF beam to construct an NF spot beam.

We consider that the WTRU can construct an NF beam through selecting an FF beam and a beamfocusing parameter to be applied to this FF beam.

A beamfocusing parameter may correspond to one or more phase correction factors (e.g., phase correction vectors). For instance, for a given FF beam, a beamfocusing parameter may correspond to a phase correction factor while for different FF beams a beamfocusing parameter may correspond to different phase correction factors.

In another example, for different FF beams a beamfocusing parameter may correspond to the same phase correction factor.

The beamfocusing parameter c may take various forms. For instance, the beamfocusing parameter can be expressed as a function of one or more constants, which may be configurable, and a distance r, which the WTRU may determine, explicitly or implicitly. The distance r could represent, for example, the distance between the WTRU, e.g., a WTRU antenna, WTRU antenna array, or WTRU antenna panel, and a TRP, e.g., a reference point in a TRP antenna array such as the center, an edge or a corner, or the distance between a scatterer and a TRP. As an example, c can be expressed as a function of the distance r and a constant A, such that:

$$c = f ( r , A ) . \qquad ( 1 )$$

In one example, the beamfocusing parameter c may be inversely proportional to the distance r such as c=A/r, or the beamfocusing parameter may be proportional to r, such as c=A*r.

In another example, the beamfocusing parameter can be represented as a function of the distance r, the wavelength λ, which may be configured to or determined by the WTRU, and one or more constants. For example, c can be expressed as a function of the distance r, the wavelength λ, and a constant A:

$$c = f ( r , λ , A ) . \qquad ( 2 )$$

In this disclosure, for brevity, we consider the example that the beamfocusing parameter c is inversely proportional to r, specifically, c≙Δ²/2r. However, the proposed embodiments in this disclosure are applicable for any form of c, e.g., as in the examples above.

It can be noted that some embodiments herein are described such that increasing the distance r (e.g., as WTRU moves away from a TRP) corresponds to a decreasing of a beamfocusing parameter c, with may be in accordance with the considered example that c is inversely proportional to r. Similarly, decreasing the distance r (e.g., as WTRU moves towards a TRP) may correspond to increasing a beamfocusing parameter c, in the considered example. If a different form of c is used, e.g., a form in which c is proportional to r, one or more embodiments may be adjusted accordingly, so that increasing a distance r leads to increasing the value of beamfocusing parameter c and decreasing a distance r leads to decreasing the value of beamfocusing parameter c, etc.

### [Precoding/Precoder]

In MIMO, precoding can be used to generate a set of composite propagation paths which have increased orthogonality, i.e., precoding helps to improve the performance of MIMO when using a propagation channel. In our case, a WTRU may report a precoding/precoder to the network, so that the gNB/TRP/network node receiving the report may adapt its DL transmissions to the WTRU according to the reported precoding/precoder (in other words the gNB/TRP/network node may use the reported precoding/precoder in its DL transmissions to the WTRU), for improved reception of these transmissions by the WTRU.

### [Precoder Types]

A precoder can be constructed from various components. A precoder type may correspond to a set of components and one or more method(s) to construct a precoder from the set of components.

The different precoder types may capture different aspects of the channel. For instance, one precoder type might lack the ability to perform distance-dependent beamforming, whereas another precoder type may be specifically designed to account for the UE distance and adjust the precoder attributes values accordingly.

On the other hand, precoders of the same type share a common structure and may be described using an identical set of components. However, they may differ in the specific values assigned to those components, leading to variations in their performance. These differences allow for fine-tuning of the precoder's behavior without altering its type, thus providing flexibility to meet diverse channel conditions while adhering to the same general structure.

The construction of precoders using the method(s) corresponding to a precoder type may yield a variety of different precoders corresponding to the precoder type for a variety of different values of the set of components corresponding to the precoder type.

Consider an FF precoder type as a first example of a precoder type. The set of components may comprise one or more FF beam(s) and one or more corresponding scalar co-phasing factor(s). The construction method(s) may comprise the sum of the FF beam(s) multiplied with the corresponding co-phasing factor(s). For different FF beam(s) and/or co-phasing factor(s), different precoders of the same precoder type may be constructed.

Consider a hybrid NF/FF precoder type as a second example of a precoder type. The set of components may comprise a first set of FF beam(s) and one or more corresponding scalar co-phasing factor(s), a second set of FF beam(s) and corresponding phase correction vector(s). The construction method(s) may comprise the sum of the FF beam(s) in the first set multiplied with the corresponding co-phasing factor(s) plus the FF beam(s) in the second set element-wise multiplied with the corresponding phase correction vector(s). For different sets of FF beam(s), co-phasing factor(s), and/or phase correction vectors, different precoders of the same precoder type may be constructed.

### [NF Precoder]

The term NF precoder may refer to a precoder comprising one or more NF beams. It may also refer to a PMI that corresponds to a precoder comprising one or more NF beams.

An NF precoder may comprise only NF beams. In other cases, an NF precoder may comprise both NF beams and FF beams, also called a hybrid NF-FF precoder.

An NF precoder may be represented by a vector or a matrix.

In an example, a vector NF precoder may correspond to single-layer transmission, whereby a symbol of the layer may be multiplied by the vector to generate transmission symbols for multiple transmitter chains.

In another example, a matrix NF precoder may correspond to multi-layer transmission, whereby for instance a symbol of a first layer may be multiplied by a first column (or row) of the matrix to generate first layer transmission symbols for the multiple transmitter chains, and a symbol of a second layer may be multiplied by a second column (or row) of the matrix to generate second layer transmission symbols for the multiple transmitter chains, etc., wherein the transmission symbols from multiple layers for a transmitted chain may be combined, e.g., by addition.

[NF Precoder with Per-FF Beam Beamfocusing Parameter]

This refers to an NF precoder comprising one or more NF beams constructed using separate beamfocusing parameters. In particular, each NF beam is constructed using an FF beam and a corresponding beamfocusing parameter.

NF precoder with per-FF beam beamfocusing parameter may also refer to an NF precoder constructed through applying beamfocusing parameters on the FF beam level.

NF precoder with per-FF beam beamfocusing parameter indicates an NF precoder with per-NF beam focus distance.

[NF Precoder with Per Group of FF Beams Beamfocusing Parameter]

This refers to an NF precoder comprising multiple NF beams where more than one NF beam may be constructed using the same beamfocusing parameter. In particular, more than one NF beams are constructed through grouping multiple FF beams and applying a common beamfocusing parameter to the grouped FF beams.

There may be multiple groups of FF beams in an NF precoder, where a common beamfocusing parameter is applied to each group and separate beamfocusing parameters are applied to different groups of FF beams.

The NF beams from a group of FF beams are constructed using the same beamfocusing parameter. NF precoder with per group of FF beam beamfocusing parameter may also refer to an NF precoder constructed through applying beamfocusing parameters on the FF precoder level, e.g., all selected FF beams are grouped together in one group and same beamfocusing parameter is applied to construct all NF beams within the NF precoder.

NF precoder with per group of FF beam beamfocusing parameter indicates an NF precoder with per group of NF beams focus distance, e.g., one or more NF beams (a group of NF beams) are constructed considering same focus distance.

[NF Precoder with a Single Beamfocusing Parameter]

This refers to an NF precoder comprising one or more NF beams where all NF beams are constructed using the same beamfocusing parameter.

NF precoder with a single beamfocusing parameter indicates an NF precoder including one or more NF beams that are constructed considering the same focus distance.

### [Hybrid NF-FF Precoder]

This refers to a precoder comprising a combination of NF and FF beams, e.g., where one or more beamfocusing parameters are applied to some of selected FF beams to construct one or more NF beams.

Hybrid NF-FF precoder may refer to a precoder comprising an FF precoder and an NF precoder, e.g., an FF precoder is added to an NF precoder to construct a hybrid NF-FF precoder.

[NF Precoder with Layer-Dependent Beamfocusing Parameters]

This refers to an NF precoder for which WTRU separately reports beamfocusing parameters for different transmission layers, e.g., WTRU reports one or more beamfocusing parameters for each transmission layer.

[NF Precoder with Layer-Independent Beamfocusing Parameters]

This refers to an NF precoder for which WTRU reports common beamfocusing parameters to be applied for one or more transmission layers.

[NF Precoder with a Specific Phase Calculation Function]

This refers to an NF precoder for which a specific phase calculation function indicated in calculation of phase correction vector (to be indicated in constructing NF beam from an FF beam) as a function of selected beamfocusing parameter.

For instance, the phase calculation function may refer to a function based first order Taylor series approximation to indicate an NF precoder with phase calculation function based on first order Taylor series approximation or a function based on second order Taylor series approximation an NF precoder with phase calculation function based on second order Taylor series approximation, etc.

### [CSI Report]

This may indicate a periodic or semi-persistent CSI report transmitted over PUCCH. Alternatively, this may indicate aperiodic or semi-persistent CSI report transmitted over PUSCH.

### [Region]

The term region may indicate:
one or more distance ranges, e.g., a maximum and/or minimum distance defining a distance range;
one or more angle ranges, e.g., a maximum and/or minimum angle defining an angle range; or a combination thereof.

WTRU may be configured with different regions where each region is associated with region ID/index.

A region may include one or more zones where each zone may be defined by (e.g., associated with) a distance range and/or an angle range.

A region may correspond to an NF region, an FF region, a focus region, inner focus region, outer focus region, focus region boundary, outside focus region, etc.

Region type may also refer to an NF region, an FF region, a focus region, inner focus region, outer focus region, focus region boundary, outside focus region, etc.

### [Angle/Angle Range]

This may refer to the angle between the WTRU antenna(s) and a TRP antenna array, e.g., angle between the WTRU and a UPA in the TRP. In addition, it may refer to the angle, e.g., of a transmitted FF beam, from the perspective of the TRP where each FF beam corresponds to a specific angle.

The angle may be measured w.r.t a TRP reference direction based on orientation of the TRP's antenna array, e.g., UPA. For instance, angle may be measured w.r.t the bore sight of the UPA in a TRP.

Angle may represent a zenith/elevation angle an azimuth angle or both, e.g., a combination thereof.

Angle range refers to a range of angles which can be described, e.g., by a minimum angle and a maximum angle.

### [Distance/Distance Range]

This may refer to the distance between the WTRU and a TRP or the distance between a TRP and a scatterer.

Distance range refers to a range of distances which can be described, e.g., by a minimum distance and a maximum distance.

### [Region Switching]

A WTRU may be configured with different regions. Region switching indicates that from a certain time instant (e.g., time instant for determining a precoder type) to another time instant (e.g., time instant for performing measurements for precoder type switching), WTRU changes its region (e.g., WTRU moves from one region to another region).

### [Precoder Type Switching]

This may refer to the WTRU action of performing one or more measurements to determine a new precoder type for PMI reporting.

This may refer to the WTRU action of changing a previous precoder type indicated in PMI reporting.

The new determined precoder type when WTRU determines to perform precoder type switching may be different from or similar to a previous determined precoder type (in the latter case, there would be no precoder type switching).

### [Nearby Scatterers]

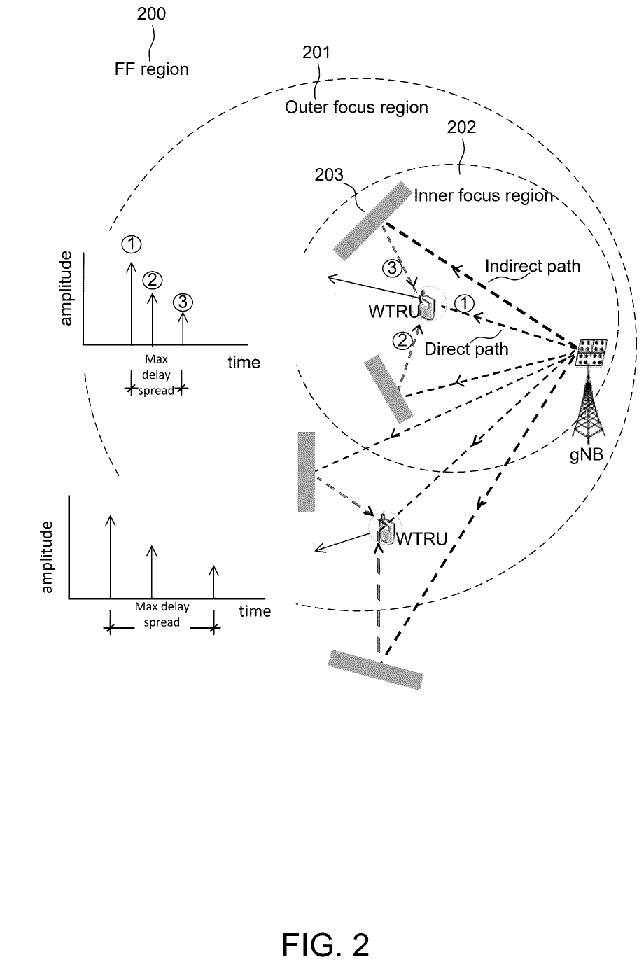

A nearby scatterer (a radio wave reflecting object, e.g., the grey bars 203 in FIG. 2) may indicate one or more physical objects from which the WTRU may receive a reflection path with a good power level (e.g., above a threshold)

Additionally, a nearby scatterer may indicate one or more physical object located, for example, in the same region as the WTRU, or in the closest region to the WTRU, and that can provide a reflection path to the WTRU with a good power level (e.g., above a threshold).

### [DL RSs]

Downlink reference signals (RSS) may refer to one or more channel state information reference signal (CSI-RS) resource(s), e.g., one or more single-port or multi-port CSI-RS resources.

Additionally, a DL RS may refer to a synchronization signal (SS) and/or physical broadcast channel (PBCH) block (e.g., SS/PBCH block or SSB).

More generally, a DL RS may for example refer to CSI-RS, SSB, physical DL control channel (PDCCH) demodulation RS (DMRS), physical downlink shared channel (PDSCH) DMRS, positioning RS (PRS), etc.

### [NF Region]

This refers to a region within which the electromagnetic wavefronts must be accurately modeled as spherical waves, e.g., because modeling electromagnetic wavefronts in such region as planar waves is inaccurate/inappropriate.

In one example, the NF region may be characterized by the Rayleigh distance R which can be used as the demarcation boundary between the Fresnel zone/region and the far (Fraunhofer) zone/region. The Rayleigh distance R is defined to be R=2D²/λ, where D is the smallest diameter of a circle that encloses the array aperture and λ is wavelength.

In another example, the NF region may be characterized by the effective Rayleigh distance R_{eff}.

The NF region is the region within which the distance between any point within the region and a TRP is smaller than for example the Rayleigh distance or the effective Rayleigh distance, or a calculated distance based on one or more configured parameters into the WTRU, etc.

The WTRU may be configured with one or more parameters to determine the boundary (e.g., the Rayleigh distance, the effective Rayleigh distance, etc.) between the NF and FF region.

The WTRU may be configured with a distance indicating the NF region (e.g., NF region is the region within which the distance between any point within the region and a TRP is below the configured distance).

An NF region may correspond to a region within which distance-based beamfocusing is beneficial enough, e.g., due to the gain from beamfocusing, and, in some cases, due to the enhanced ability to spatially multiple different UEs at different distances and/or directions, etc.

The NF region may be a region within which the FF beamforming gain drops below a certain level relative to the maximum gain e.g., of the NF spot beam.

### [FF Region]

See also FIG. 2 (200). This refers to a region in which the radio wave propagation can be accurately modeled as a planar wave.

The FF region is the region within which the distance between any point with the region and a TRP is greater than for example the Rayleigh distance or the effective Rayleigh distance, or a calculated distance based on one or more configured parameters into the WTRU, etc.

The WTRU may be configured with a distance indicating the FF region (e.g., NF region is the region within which the distance between any point within the region and a TRP is above the configured distance).

A FF region may correspond to a region within which distance-based beamfocusing is not beneficial enough, e.g., since the gain from using distance-based beamfocusing compared to direction-based beamforming is minor.

The FF region may be defined as the area outside the focus region.

The FF region may be a region within which NF spot beams have unlimited depth of focus.

### [Focus Region]

This refers to an NF region within which a TRP can generate, and/or a WTRU can receive, NF spot beams with a finite depth of focus.

The depth of focus indicates the distance/region within which the intensity of the NF spot beam does not fall below a certain threshold (e.g., 3 dB a.k.a 3 dB depth of focus).

The focus region may be characterized as a function of the Rayleigh distance where for a 3 dB depth of focus, the corresponding distance for the focus region (r_{f}) may be expressed by r≈0.1R. In general, r_{f} may be expressed by r_{f}=αR, where α<1.

Within the focus region, a TRP can send one or more non-overlapping NF spot beams in the same direction.

A focus region may correspond to a region within which distance-based beamfocusing is beneficial enough, e.g., due to the gain from beamfocusing, and, in some cases, due to the enhanced ability to spatially multiple different UEs at different distances and/or directions, etc.

The focus region may be a region within which the FF beamforming gain drops below a certain level relative to the maximum gain e.g., of the NF spot beam.

[Inner focus region]

See FIG. 2 (202). This refers to a region within the focus region that is more close to a TRP. A WTRU located in the inner focus region can receive spot beams with smaller depth of focus.

The inner focus region may be defined as the region within which a maximum depth of focus is below a threshold.

The distance range for the inner focus region (r_{if}) can be defined as a function of the distance range of the focus region as follows r_{if}=∈r_{f} where ∈<1, and e may depend on the maximum configured depth of focus for the inner focus region.

### [Outer Focus Region]

See also FIG. 2 (201). This refers to a region within the focus region that is less close to a TRP. A WTRU located in the outer focus region can receive spot beams with larger depth of focus compared to a WTRU located in the inner focus region.

The outer focus region may be defined as the region within which a minimum depth of focus is above a threshold, and the maximum depth of focus is finite (e.g., below a threshold).

The distance range for the outer focus region (r_{of}) can be defined as a function of the distance range of the focus region as follows r_{f}>r_{of}>∈r_{f}.

### [Focus Region Boundary]

This defines the NF region in which the NF spot beam starts to converge towards an FF beam, e.g., depth of focus is above a threshold.

The focus region boundary may be defined as an NF region around the distance r_{f} from the TRP. For instance, the focus region boundary may represent the region spanning the following distance range εr_{f}: ρr_{f}, where ε<1 and ρ>1.

### [Outside Focus Region]

This defines the NF region in which the NF spot beam shape becomes more closer to the FF beam shape.

Outside focus region may be defined as an NF region in which the distance between any point within the region and the TRP is above a threshold (e.g., R>r>δr_{f} where δ>1).

### [Phase Correction Vector]

A phase correction vector b represents a vector to be applied to an FF beam v^{FF} to construct an NF beam v^{NF}, e.g., v^{NF}=v^{FF}⊙b.

The phase correction vector can be represented as a function of the distance between the WTRU and a TRP as well as the angle between the WTRU and a TRP.

In case the WTRU is located at larger distances from a TRP (e.g., WTRU is located at outer focus region, focus region boundary, etc.), the impact of the distance between the WTRU and a TRP becomes more dominated w.r.t the angle (e.g., phase correction vector can be determined using a first order Taylor series approximation)

As the WTRU moves closer to a TRP (e.g., WTRU is located within inner focus region, etc.), the angle impact becomes as significant as the distance impact (e.g., phase correction vector can be determined using a second order Taylor series approximation)

### [Delay Spread]

Delay spread of a DL and/or UL radio channel may be defined as: Root Mean Square (RMS) delay spread which indicating a weighted version of the delay spread that accounts for the power of each multipath component; the maximum delay spread indicating the difference between the earliest and latest multipath components arrival times; the effective delay spread indicating the difference between the earliest multipath component and the latest multipath component with power level above a configured threshold; the time difference between the reception of the first detected channel path (in time) and the last detected channel path (in time), e.g., such as in a downlink frame from a cell, e.g., a serving cell; the RMS delay spread of the set of detected paths (in time), e.g., such as in a downlink frame from a cell, e.g., a serving cell; the RMS delay spread of the set of detected paths with power level above a threshold (in time), e.g., such as in a downlink frame from a cell, e.g., a serving cell; etc.

### [Configuration]

In this disclosure, the WTRU is “configured with” may refer to the scenario that the WTRU receives a configuration (e.g., static, dynamic, semi-persistent) from the gNB or another node, e.g., using RRC signaling.

The WTRU is “configured” or “(pre)-configured” to perform an action may also refer to the scenario that the WTRU is hard coded to perform the action via standard specifications.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

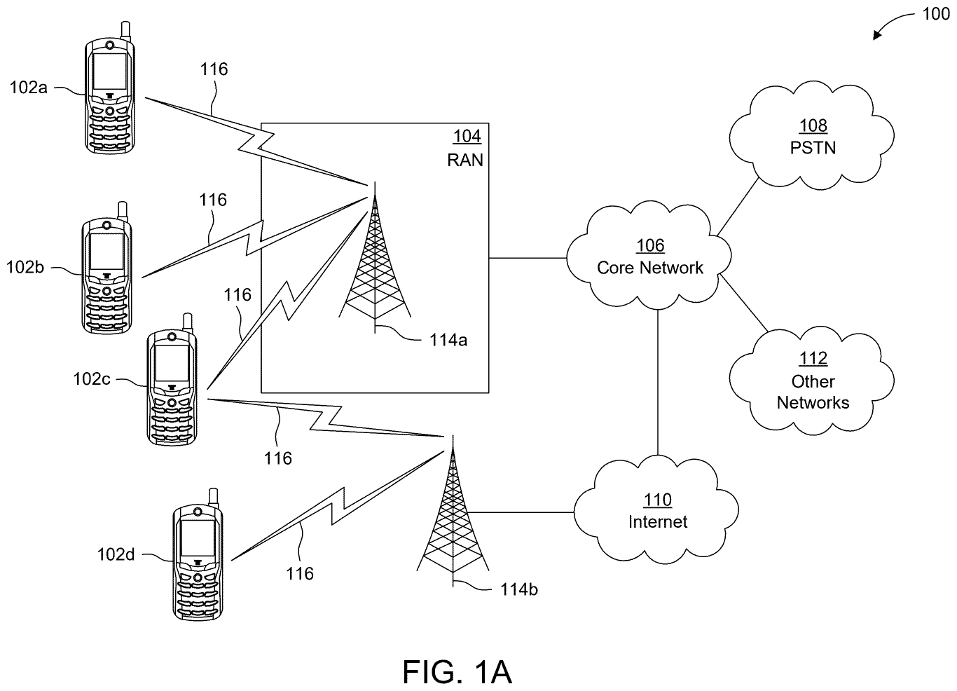

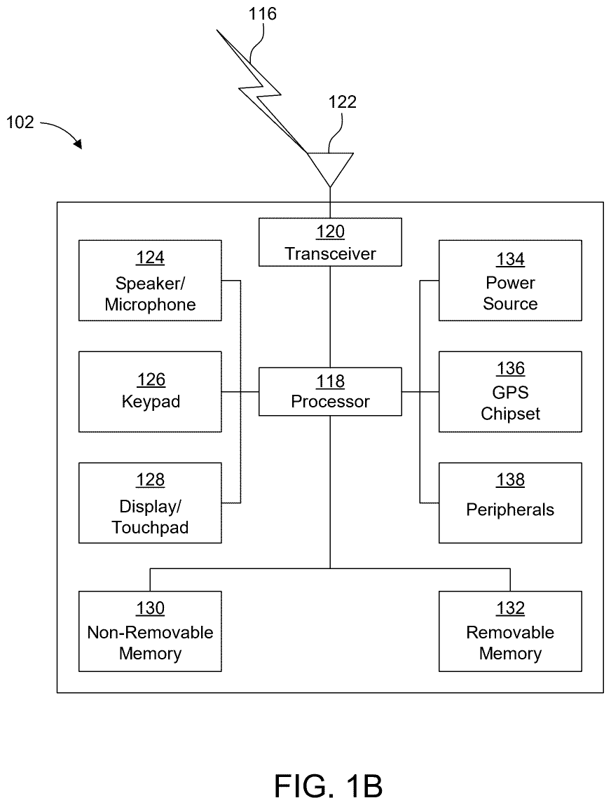

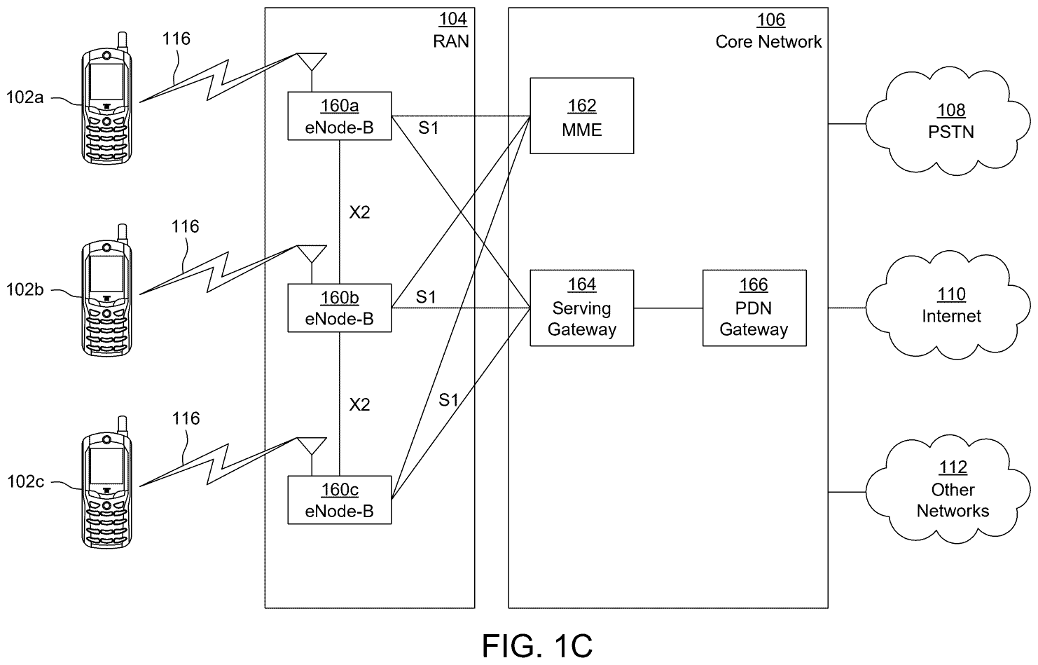

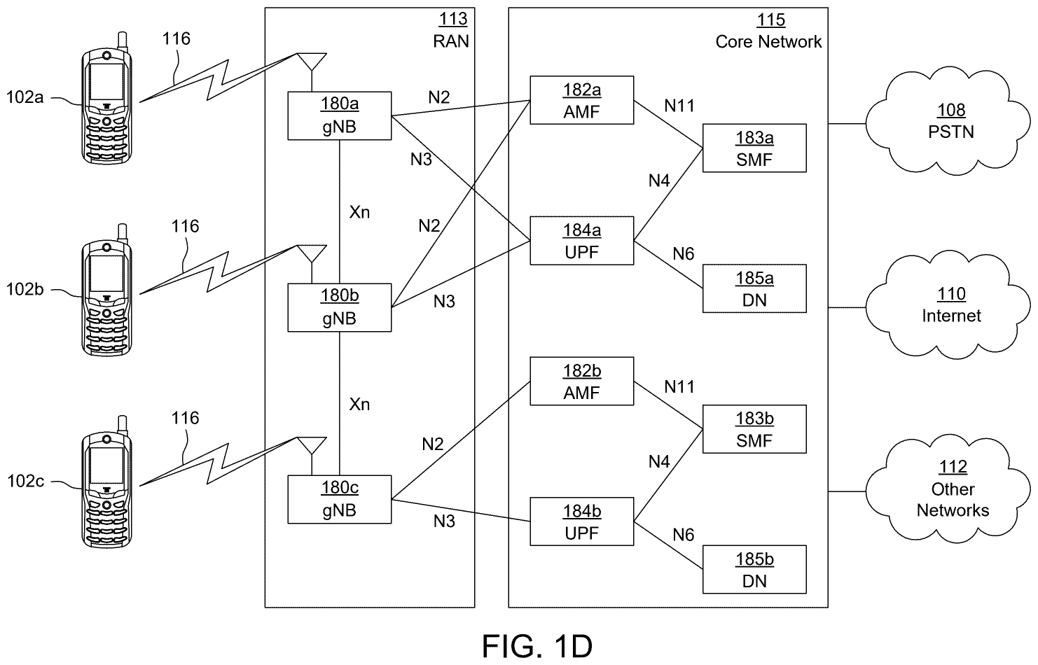

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via cither hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11c DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a l MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Massive MIMO is one of the most successful technologies in recent wireless communication systems, such as 5G. In a traditional massive multiple-input multiple-output (MIMO) system, transmission and reception point (TRP) is equipped with a large number of antennas. Legacy massive MIMO communication systems are typically designed based on the assumption that the transmission/reception happens in the far field (FF), which means that the radio wave propagation can be accurately modeled as a planar wave. However, with increasingly large TRP arrays in relation to the wavelength, and with denser TRP deployments, the likelihood of UEs being located within the Fresnel region in which Near Field (NF) propagation takes place increases. The Rayleigh distance R can be used as the demarcation boundary between the Fresnel zone and the far (Fraunhofer) zone. The Rayleigh distance R is defined to be R=2D²/λ, where D is the smallest diameter of a circle that encloses the array aperture and λ is wavelength.

In NF, the planar wave approximation in no longer accurate and electromagnetic wavefronts must be accurately modeled as spherical waves instead of planar waves. Accordingly, applying legacy FF transmission and reception techniques for a WTRU located within the NF region may lead to performance losses, e.g., reduced array gains.

### [Enabling Determination by the WTRU of the Appropriate Precoder to be Reported to the Network]

### [[Scenario and Use Cases]]

The main scenario considered here involves a WTRU in a cell with hybrid field operation and the WTRU moving between different regions, e.g., FF region, NF region, focus region, etc. Also, a WTRU with a multi-path channel may experience some paths with NF propagation and other paths with FF propagation, e.g., a reflection from the FF into the NF.

### [[Assumptions]]

The WTRU is configured with multiple precoder types, e.g., FF precoder, NF precoders, hybrid FF-NF precoder, etc.

### [[Short Description of Current Techniques]]

The legacy Channel State Information (CSI) framework is optimized for users located in FF region.

### [[Shortcomings of Current Techniques]]

Taking into account the NF propagation, a cell or a WTRU may experience a hybrid field operation; different NF precoders may be configured into the WTRU to enable NF beamfocusing at different parts of the cell;

Different precoder types have different complexity of determining the different parameters constructing the precoder and different signalling overhead;

The legacy CSI framework doesn't support measurement-based WTRU switching between various precoders/precoder types. For example, as the WTRU moves between different regions, it will apply the same precoder type (e.g., an FF precoder, an NF precoder). This may lead to: performance degradation, e.g., if an FF precoder is used while being located in an NF region; higher complexity and reporting overhead, e.g., if an NF precoder is used while being located in the FF region; etc.

Thus, determining the right (appropriate) precoder type (e.g., the precoder type that can provide a comparable performance to the maximum possible performance while potentially reducing the overhead) is a necessity when WTRU operates in a cell with a hybrid field operation.

Summary of an embodiment to enhance CSI framework to enable the determination of the right/appropriate precoder type for reporting to the network via precoding matrix indicator (PMI) reporting:

An NF precoder is constructed from one or more NF beams, corresponding to NF channel paths, while a hybrid NF-FF precoder is constructed from both NF and FF beams, corresponding to both NF channel paths and FF channel paths. NF channel paths are associated with shorter propagation delay, while FF channel paths are associated with longer propagation delay. Therefore, this embodiment uses a measurement, i.e., the WTRU-measured channel delay spread as a means to trigger switching between an NF precoder type and an FF precoder type.

Among the benefits of the above embodiment, is that it enables to select the right/appropriate precoder type for the region in which the WTRU is situated, report the selected precoder type to the network, may thus improve accuracy of MIMO precoding on the network side for improved reception of DL transmissions from the network by the WTRU.

### [Framework for Determining the Right/Appropriate Precoder Type]

A WTRU located in a cell with hybrid-field operation may experience varying conditions that may influence the selection of the appropriate precoder type to be indicated in PMI reporting. For instance, as the WTRU moves through different regions of the cell, such as transitioning from the near-field (NF) region to the far-field (FF) region, or vice versa, WTRU need to adjust the precoder type for PMI reporting. This ensures that the WTRU maintains optimal performance while minimizing signaling overhead and computational complexity associated with determining precoder attributes.

Additionally, for a WTRU located in the NF region, WTRU may experience different conditions that may alter the preferred precoder type to be used:
For instance, according to an embodiment, a WTRU may construct one or more NF beams constructing the NF precoder using a single beamfocusing parameter, e.g., in case WTRU is located near the focus region boundary where the NF spot beam shape converges towards the FF beam shape;
For instance, according to an embodiment, a WTRU may construct one or more NF beams constructing the NF precoder using a separate beamfocusing parameter for each FF beam, e.g., in case WTRU is located in the inner focus region where the NF spot beam becomes more focused and the required phase correction vector for constructing an NF beam becomes dependent on both the angle of the FF beam and the focus distance;
For instance, according to an embodiment WTRU may construct a precoder that include one or more NF beams and one or more FF beams, e.g., in case WTRU receives multipath components with good power level from a scatterer that is located in the FF region.

Given the diversity of required precoders types when WTRU experiences hybrid field operation or is located in a cell with hybrid field operation, in this disclosure, we explore various WTRU measurements, preferably with low additional complexity, that can be used to have a better understanding of the WTRU surrounding conditions. Additionally, we consider the conditions that can be configured into the WTRU based on the various measurements for: determination of the right/appropriate precoder type; determination whether precoder type switching is required or not.

Thus, through performing one or more measurements and applying one or more configured conditions from the NW based on one or more of the performed measurements, a WTRU may determine: whether it needs to switch the precoder type (e.g., performing one or more measurements for determining a new precoder type); the right/appropriate precoder type to be indicated in PMI reporting.

The considered measurements in this disclosure include but are not limited to: delay spread measurements, as the delay spread may be a good indication of propagation field of the channel multipath components received by the WTRU and hence, can be indicated in precoder type determination, as indicated in FIG. 2; WTRU region detection, since a WTRU may apply a specific precoder type based on the region in which it is located; WTRU sensing of surrounding environment, where WTRU sensing of whether it has nearby scatterers as well as WTRU sensing of the location of nearby scatters, may impact the choice of the precoder type to be used.

### [WTRU Configuration]

### [[WTRU Configuration of Different Precoder Types]]

According to embodiments, a WTRU may be configured with one or more precoder types, e.g., one or more of the following precoder types: FF precoder; NF precoder; Hybrid NF-FF precoder; NF precoder with per-FF beam beamfocusing parameter; NF precoder with per group of FF beams beamfocusing parameter; NF precoder with a single beamfocusing parameter; NF precoder with layer-dependent beamfocusing parameters; NF precoder with layer-independent beamfocusing parameters; NF precoder with a specific phase calculation function, e.g., a phase calculation function based on first order Taylor series approximation, or a phase calculation function based on second order Taylor series approximation.

### [[WTRU Configuration for Performing Measurements]]

A WTRU may be configured to perform one or more measurements for determining: whether to switch precoder type; the precoder type to be indicated in PMI reporting.

A WTRU may be configured with one or more DL RS (e.g., CSI-RS) for performing measurements, for instance: DL RSs for performing measurements for precoder type switching; DL RSs for determining the right/appropriate precoder type. E.g., WTRU may be configured with association between DL RS configurations and measurements type, e.g., measurements for determining whether to switch precoder type, measurements for precoder type determination).

For instance, a WTRU may be configured with: one or more periodic DL RSs; one or more semipersistent DL RSs; one or more aperiodic DL RSs.

In one example, a WTRU may receive RRC configurations indicating periodicity of one or more measurements for precoder type switching (e.g., periodicity of DL RSs associated with the measurements).

In another example, a WTRU may receive MAC CE indicating activation of one or more measurements (e.g., activation of DL RSs associated with the measurements).

In yet another example, WTRU may receive DL DCI triggering one or more measurements.

### [[WTRU Configurations of Different Regions]]

### [[[Configurations of Parameters for Determining Different Regions]]]

In an embodiment, WTRU may be configured with one or more parameters for identifying different regions in a cell.

In one example, WTRU may be configured with different regions where each region is associated with a region index. Also, WTRU may be configured with different distance and/or angle ranges. Additionally, WTRU may be configured with association between the configured one or more regions and: the configured one or more distance ranges; and/or the configured one or more angle ranges. For instance: a first region may be associated with a first distance range and/or a first angle range; a second region may be associated with a second distance range and/or a second angle range.

In another example, WTRU may be configured with different regions. Also, for each region, WTRU may be configured with one or more parameters identifying the region. For instance: for a first region (e.g., NF region), WTRU may be configured with a first set of parameters (e.g., one or more parameters) identifying the distance range and/or angle range of the first region; for a second region (e.g., focus region), WTRU may be configured with a second set of parameters (e.g., one or more parameters) identifying the distance range and/or angle range of the second region.

Section “Framework for Determining the Right/Appropriate Precoder Type” includes a description of one or more of the parameters to be configured to (associated with) a region for identifying the distance and/or angle ranges.

In yet another embodiment, a WTRU may be configured with one or more zones where each zone is associated with zone ID. Also, each zone may be associated with a DL RS. Additionally, a WTRU may be configured with association between different regions and different configured zones, e.g.: one to one mapping between configured regions and configured zones. Each region may be associated with zone ID which indicates also that each region is associated with a DL RS; one to many mapping between configured regions and configured zones. Each region may be associated with one or more zone IDs which indicates also that each region is associated with one or more DL RSs.

In yet another embodiment, a WTRU may be configured with association between regions and one or more measured performance metrics (e.g., SINR/RSRP/CQI): a first region may be associated with a first RSRP/SINR range (e.g., in dB, dBm, or linear scale); a first region may be associated with a first CQI range; a second region may be associated with a second RSRP/SINR range (e.g., in dB, dBm, or linear scale); a second region may be associated with a second CQI range.

In yet another embodiment, a WTRU may be configured with association between regions and the difference or ratio between one or more measured performance metrics over two different DL RSs (e.g., SINR/RSRP): a first region may be associated with a first range of the difference between measured RSRP/SINR on two different DL RSs (e.g., difference in dB, dBm, absolute difference in dB, dBm, etc.); a first region may be associated with a first range of the ratio between a first measured and a second measured RSRP/SINRs on two different DL RSs (e.g., ratio in linear scale); a second region may be associated with a second range of the difference between measured RSRP/SINR on two different DL RSs (e.g., difference in dB, dBm, absolute difference in dB, dBm, etc.); a second region may be associated with a second range of the ratio between a first measured and a second measured RSRP/SINRs on two different DL RSs (e.g., ratio in linear scale).

### [[[Configurations of Parameters Related to Region Switching]]]

In an embodiment, a WTRU may be configured with one or more parameters related to region switching. In one example, a WTRU may be configured with one or more thresholds indicating the minimum difference between two measured performance metrics that indicates that the WTRU moved to a different region. For instance: the threshold may indicate the minimum absolute difference (e.g., in dB or dBm) between measured RSRPs/SINRs at two different time instants; the threshold may indicate the minimum absolute difference between measured CQIs at two different time instants.

In another example, a WTRU may be configured with a threshold indicating the minimum difference in measured delay spread values at different time instants that indicates that WTRU moved to a different region.

WTRU may be configured with a threshold for determining the delay spread. For instance, WTRU may be configured with a threshold indicating the minimum power level of a multipath component for delay spread calculations.

### [[[Configurations of Parameters for Sensing Environment]]]

In an embodiment, a WTRU may be configured with a threshold indicating minimum RSRP level for scatterer detection.

### [[WTRU Configurations of Conditions for Performing Precoder Type Switching]]

In an embodiment, a WTRU may be configured with one or more parameters for performing precoder type switching.

In one example, a WTRU may be configured with one or more thresholds indicating the minimum difference between two measured performance metrics for performing precoder type switching. For instance: the threshold may indicate the minimum absolute difference (e.g., in dB or dBm) between measured RSRPs/SINRs at two different time instants; the threshold may indicate the minimum absolute difference between measured CQIs at two different time instants.

In another example, a WTRU may be configured with a threshold indicating the minimum difference in measured delay spread values at different time instants for performing precoder type switching.

In yet another example, a WTRU may be configured with a threshold indicating the minimum time elapsed since determining latest precoder type or the minimum time elapsed since reporting latest precoder to perform precoder type switching.

In yet another example, a WTRU may be configured with a threshold indicating the minimum Doppler shift value for performing precoder type switching.

### [[WTRU Configurations of Conditions for Determining the Right/Appropriate Precoder Type]]

This section covers different conditions the WTRU can evaluate to determine which precoder type should be applied. The condition may be based on one or more measurements, e.g.: RSRP/SINR is above/below a threshold; WTRU is located in a certain region, e.g., NF region, focus region, boundary of focus region, etc.; WTRU sensing of surrounding environment, whether WTRU has surrounding nearby scatterers or not.

In an embodiment, a WTRU may be configured with one or more parameters for determining the precoder type for PMI reporting.

In one example, a WTRU may be configured with a threshold indicating a delay spread threshold for determining precoder type for PMI reporting.

In another example, a WTRU may be configured with association between one or more precoder types (e.g., each precoder type is associated with an index) and one or more regions. For instance: a first precoder type is associated with a first region; a second precoder type is associated with a second region.

In yet another example, a WTRU may be configured with association between one or more precoder types and one or more scattering profile. For instance: a first precoder type is associated with a first scattering profile; a second precoder type is associated with a second scattering profile.

In yet another example, a WTRU may be configured with association between one or more beamfocusing parameter types in an NF precoder and one or more NF precoder types. For instance: a first beamfocusing parameter type is associated with a first NF precoder type; a second beamfocusing parameter type is associated with a second NF precoder type.

Note that a threshold configuration may indicate two thresholds. For instance, a threshold configuration may indicate the two thresholds by a configured threshold and a configured hysteresis offset value, for instance such that the two thresholds may be: threshold plus hysteresis offset value (e.g., first hysteresis offset value); or threshold minus hysteresis offset value (e.g., second hysteresis offset value).

Additionally, a WTRU may be configured with association between, for example, precoder types and threshold state (may also be a threshold). For instance: a first precoder type may be associated with a first threshold state (e.g., threshold plus first hysteresis offset value); a second precoder type may be associated with a second threshold state (e.g., threshold minus second hysteresis offset value).

### [WTRU Determines Whether to Perform Precoder Type Switching Based on Measurements and Configured Conditions]

### [[WTRU Performs Measurements to Determine Whether to Perform Precoder Type Switching]

Based on the configurations, a WTRU may perform one or more measurements to determine whether to switch precoder type. The one or more measurements that WTRU performs may be: periodic measurements; semi-persistent measurements; aperiodic measurements.

In one example, a WTRU may perform the one or more measurements upon receiving one or more DL RSs configured for performing one or more measurements for precoder type switching. For instance, a WTRU may periodically perform one or more measurements using one or more configured periodic DL RSs; WTRU may semi-persistently perform one or more measurements using one or more configured semi-persistent DL RSs; WTRU may conditionally perform one or more measurements using one or more configured semi-aperiodic DL RSs.

### [[[WTRU Measures Doppler Shift]]]

In one embodiment, WTRU may measure Doppler shift using one or more of received DL RSs. For instance: WTRU may measure the Doppler shift based on a received DL RS; WTRU may measure one or more doppler shifts based on one or more received DL RSs and calculate a metric based on the one or more measured Doppler shifts, e.g.: Maximum Doppler shift, Minimum Doppler shift, Average Doppler shift, Doppler spread.

### [[[WTRU Measures Time Elapsed Since Determining Latest Precoder Type or Time Elapsed Since Reporting Latest Precoder]]]

In one embodiment, WTRU may measure time elapsed since WTRU determined the latest precoder type.

In another embodiment, WTRU may measure time elapsed since it reports the latest determined precoder.

[[[WTRU Compares its Current Region with its Previous Region (its Region when it Reported Latest Precoder, its Region when it Determined Latest Precoder Type)]]]

In one embodiment, WTRU may determine its current region using one or more of received DL RSs. For instance, WTRU may measure one or more RSRPs, SINR (e.g., RSRP/SINR may be measured in dBm, dB or may be measured in linear scale) based on one or more DL RSs: WTRU may measure one RSRP/SINR using a received DL RS. Then, WTRU may determine its current region based on configured association between the measured RSRP/SINR and different regions; WTRU may measure the RSRPs/SINRs for two different DL RSs. Then, WTRU may determine the difference between the Two RSRP/SINR values, e.g., difference in dBm or dB, absolute difference in dB or dBm, etc. WTRU may determine its region based on the configured association between the difference between the two measured RSRP/SINR values and different regions; WTRU may measure the RSRPs/SINRs for two different DL RSs. Then, WTRU may determine the ratio between the Two RSRP/SINR values. WTRU may determine its region based on the configured association between the ratio between the two measured RSRP/SINR values and different regions, e.g., ratio in linear scale.

In another embodiment, WTRU may determine its distance from a TRP to determine its region. WTRU may be configured with associations between different distance ranges and different regions. WTRU may determine its distance with a TRP based on: measurement(s) on one or more received RS(s), e.g., WTRU measures RSRP, SINR, pathloss (e.g., WTRU may measure RSRP, SINR, pathloss in dB, dBm or in linear scale), and uses the measurement results to determine its distance with a TRP. WTRU may be configured with a mapping between the measurement results and the corresponding distance information. In another example, the WTRU may autonomously determine its distance with a TRP based on the measured RSRP, SINR, pathloss, etc.; based on WTRU positioning; based on WTRU sensing of the environment.

WTRU may compare the current determined region with a previous determined region, where the previous region may be determined using one or any combination of above methods for WTRU region determination, to determine whether it switches to a different region or not.

### [[[WTRU Determines Whether it Switches to a Different Region Based on the Difference Between One or More Metrics Calculated at Different Time Instants]]]

In one embodiment, a WTRU may measure the difference between a measured metric at different time instants based on received DL RSs. For instance, a WTRU may measure a current metric (e.g., RSRP, SINR, CQI, etc.) based on one or more received DL RSs and compare the measured metric with a previous measured metric (e.g., a metric that was measured when WTRU determines previous precoder or report previous precoder). For instance: WTRU may determine that WTRU may determine that it switches to a different region if the absolute difference between a current measured metric and a previous metric is above a threshold; WTRU may determine that WTRU may determine that it does not switch to a different region if the absolute difference between a current measured metric and a previous metric is below a threshold.

### [[[WTRU Determines Whether it Switches to a Different Region Based on the Difference Between a Current and a Previous Measured Delay Spread]]]

In one embodiment, WTRU may measure the difference between a current measured delay spread and a previous measured delay spread (a previous delay spread may be measured when WTRU determines previous precoder or report previous precoder). The WTRU may measure the delay spread based on one or more received DL RSs. For instance: WTRU may determine that WTRU may determine that it switches to a different region if the absolute difference between a current measured delay spread and a previous measured delay spread is above a threshold; WTRU may determine that WTRU may determine that it does not switch to a different region if the absolute difference between a current measured delay spread and a previous measured delay spread is below a threshold.

### [[WTRU Applies Conditions for Determining Whether to Perform Precoder Type Switching]]

A WTRU may determine to perform precoder type switching (e.g., WTRU performs one or more measurements to determine a new precoder type to be indicated in PMI reporting) based on one or more of performed measurements and configured conditions. In particular, WTRU may determine whether to perform precoder type switching using one or any combination of the following.

### [[[Conditions Based on Region Switching]]]

In one example, WTRU may determine whether to perform precoder type switching (e.g., WTRU performs one or more measurements to determine a precoder type to be indicated in PMI reporting) based on WTRU determination of its region switching status. For instance: in case WTRU determines that it switches its region based on one more measurement, WTRU performs precoder type switching; in case WTRU determines that it does not switch its region based on one more measurement, WTRU does not perform precoder type switching.

Region switching triggering the changing of the precoder type may be beneficial since the preferred/right/appropriate precoder type to be indicated in PMI reporting may differ based on the region in which the WTRU is.

### [[[Conditions Based on Difference Between a Current and a Previous Performance Metric]]]

In one example, a WTRU may determine whether to perform precoder type switching (e.g., WTRU performs one or more measurements to determine a precoder type to be indicated in PMI reporting) based on WTRU comparison between a current and a previous measured performance metric. In particular, a WTRU may measure a current metric (e.g., RSRP, SINR, CQI, etc.) based on one or more received DL RSs. Then, the WTRU determines the difference between the measured metric and a previous measured metric (e.g., a metric that was measured when the WTRU determines previous precoder or report previous precoder). Then:

In case the calculated difference (e.g., in dB, dBm or in linear scale) between the current and previous measured metric is above a threshold (e.g., |SINRₜ_{₁}−SINRₜ_{₂}|>th₁, |RSRPₜ_{₁}−RSRPₜ_{₂}|>th₂, etc.), WTRU performs precoder type switching;

In case the calculated difference (e.g., in dB, dBm or in linear scale) between the current and previous measured metric is below a threshold (e.g., |SINRₜ_{₁}−SINRₜ_{₂}|<th₁, |RSRPₜ_{₁}−RSRPₜ_{₂}|<th₂, etc.), WTRU does not perform precoder type switching.

In case WTRU experiences large difference in a measured metric at two different time instants, this may be an indication that the WTRU experience different surrounding conditions and thus it may be beneficial to switch precoder type to account for the new WTRU conditions.

### [[[Conditions Based on Difference Between a Current and a Previous Delay Spread]]]

In one example, WTRU may determine whether to perform precoder type switching (e.g., WTRU performs one or more measurements to determine a precoder type to be indicated in PMI reporting) based on WTRU comparison between a current and a previous measured delay spread:

In case the calculated difference between the current and previous measured delay spread is above a threshold, WTRU performs precoder type switching.

In case the calculated difference between the current and previous measured metric is below a threshold, WTRU does not perform precoder type switching.

In case WTRU experiences large difference in measured delay spread at two different time instants, this may indicate that the WTRU experiences different surrounding conditions and thus it may be beneficial to switch precoder type to account for the new WTRU conditions.

### [[[Conditions Based on Time Elapsed Since Determining Latest Precoder Type or Time Elapsed Since Reporting Latest Precoder]]]

In one example, WTRU may determine whether to perform precoder type switching (e.g., WTRU performs one or more measurements to determine a precoder type to be indicated in PMI reporting) based on WTRU measurements of time elapsed since determining latest precoder type or time elapsed since reporting latest precoder. For instance:

In case the measured time elapsed since determining latest precoder type is above a threshold, WTRU performs precoder type switching.

In case the calculated difference between the current and previous measured metric is below a threshold, the WTRU does not perform precoder type switching.

As time elapsed since reporting latest precoder (e.g., determining latest precoder type) increases, WTRU surrounding conditions may change. Thus, in case time elapsed since reporting latest precoder exceeds a certain threshold, it may be beneficial to switch precoder type.

### [[[Conditions Based on Measured Doppler Shift]]]

In one example, a WTRU may determine whether to perform precoder type switching (e.g., WTRU performs one or more measurements to determine a precoder type to be indicated in PMI reporting) based on WTRU measured Doppler shift. For instance:

In case the measured Doppler shift (e.g., maximum, minimum, average Doppler shift, Doppler spread, etc.) is above a threshold, WTRU performs precoder type switching.

In case the measured Doppler shift (e.g., maximum, minimum, average Doppler shift, Doppler spread, etc.) is below a threshold, WTRU does not perform precoder type switching.

Doppler shift represents an indication of WTRU velocity. In case WTRU velocity exceeds a certain threshold, this may reflect that WTRU experiences different surrounding conditions (e.g., moves to a different region) and thus it may be beneficial if the WTRU switches the precoder type.

### [WTRU Performs Measurements for Precoder Type Determination]

In an embodiment, WTRU performs one or more measurements to determine the precoder type to be indicated in PMI reporting.

In one example, WTRU may perform one or more measurements for precoder type determination in case WTRU determines to perform precoder type switching. In another example, WTRU may perform one or more measurements for precoder type determination in case WTRU needs to determine a PMI to be transmitted in a CSI report (e.g., WTRU receives (is configured with) CSI report configurations with a report quantity set to “cri-RI-PMI-CQI”, “cri-RI-LI-PMI-CQI”, or any quantity indicating reporting of PMI); where CRI-CSI-RS Resource Indicator; RI: Rank Indicator; PMI: Precoding Matrix Indicator; CQI: Channel Quality Indicator; LI: Layer Indicator.

### [[WTRU Measurements of Delay Spread]]

In an embodiment, WTRU may measure its delay spread based on one or more received DL RSs to determine the precoder type to be indicated in PMI reporting. For instance: WTRU may measure the delay spread based on a received DL RS; WTRU may measure one or more delay spread values based on one or more received DL RSs and calculate a metric based on the one or more measured delay spread values, e.g., Maximum delay spread, Minimum delay spread, Average delay spread.

The determined delay spread based on a received DL RS may be measured, e.g., in milliseconds, microseconds, etc.

Delay spread may be used as an indication of the characteristics of the channel paths contributing to the WTRU channel. For instance, shorter propagation delay reflects NF channel paths, while longer propagation delay reflects FF channel paths. Thus, a delay spread measurement can be beneficial and useful for determining the precoder type to be indicated in PMI reporting.

### [[WTRU Detects/Determines its Region]]

In an embodiment, a WTRU may determine its region using one or more of received DL RSs. For instance, WTRU may measure one or more RSRPs based on one or more DL RSs:

WTRU may measure one RSRP using a received DL RS. Then, WTRU may determine its current region based on configured association between the measured RSRP and different regions;

WTRU may measure the RSRPs for two different DL RSs. Then, WTRU may determine the difference between the Two RSRP values, e.g., difference in dBm or dB, absolute difference in dB or dBm, etc. WTRU may determine its region based on the configured association between the difference between the two measured RSRP values and different regions;

WTRU may measure the RSRPs for two different DL RSs. Then, WTRU may determine the ratio between the Two RSRP values. WTRU may determine its region based on the configured association between the ratio between the two measured RSRP values and different regions, e.g., ratio in linear scale.

In another embodiment, WTRU may determine its distance from a TRP to determine its region. WTRU may be configured with associations between different distance ranges and different regions. WTRU may determine its distance with a TRP based on:
measurement(s) on one or more received RS(s), e.g., WTRU measures RSRP, SINR, pathloss (e.g., WTRU may measure RSRP, SINR, pathloss in dB, dBm or in linear scale), and uses the measurement results to determine its distance with a TRP. WTRU may be configured with a mapping between the measurement results and the corresponding distance information. In another example, the WTRU may autonomously determine its distance with a TRP based on the measured RSRP, SINR, pathloss, etc.;
based on WTRU positioning;
based on WTRU sensing of the environment.

Different regions in the cell have different characteristics. Also, the preferred precoder type for PMI reporting may change from one region to another. Thus, it may be beneficial if the WTRU uses its detected region to determine the precoder type to be indicated in PMI reporting.

### [[WTRU Senses its Surrounding Environment]]

In an embodiment, WTRU may sense its surrounding environment based on one or more beamformed DL RSs. For instance, WTRU may measure one or more beamformed DL RSs where each DL RS is beamformed towards one or more zones (e.g., zone may be defined by angle range and distance range). WTRU measures one or more of the beamformed DL RSs to sense its surrounding environment. For instance:
WTRU may measure RSRP level for one or more of beamformed DL RSs;
WTRU may determine one or more DL RSs having RSRP levels above a configured threshold
WTRU may determine the one or more zones (e.g., distance and angle ranges) associated with the DL RSs whose measured RSRP levels are above a threshold;
WTRU may determine the regions of nearby scatterers (regions in which nearby scatterers are located) based on the determined zones associated with the DL RSs whose measured RSRP levels are above a threshold.

If the WTRU supports it, and perhaps anyway performs it, the WTRU sensing of the surrounding environment may be useful for the determination of the preferred precoder type for PMI reporting. For example, in case WTRU detects one or more nearby scatterers, the WTRU may construct a precoder comprising multiple NF beams. Also, identifying the region(s) of existing nearby scatters reflects whether different NF beams can be generated using same or different beamfocusing parameters.

### [WTRU Reporting of Measurements for Precoder Type Determination]

This section covers the reporting from WTRU to help the NW determines the right/appropriate precoder type. The WTRU may report one or more of the performed measurements.

In an embodiment, a WTRU may report one or more of the measurement results for precoder type determination to the NW. For instance, WTRU may report one or any combination of the following measurements:
Measured delay spread, e.g., index of a configured delay spread range to which the measured delay spread belongs, etc.;
Measured distance from a TRP, e.g., index of configured distance range to which the measured distance belongs, etc.;
Determined WTRU region, e.g., bitmap indicating the determined region, etc.;
Indicator for whether WTRU has nearby scatterers or not, e.g., Boolean variable indicating whether WTRU has nearby scatterers, etc.,

In one example, the WTRU reports one or more of the performed measurements for precoder type determination in a separate report, e.g., CSI report. In another example, the WTRU reports one or more of the performed measurements for precoder type determination jointly with a determined precoder type based on the performed measurements. In particular, WTRU may send a report (e.g., CSI report) that indicates both one or more results of the WTRU performed measurements and the determined precoder type based on the performed measurements. In yet another example, WTRU may send a report indicating only the determined precoder type based on the performed measurements, e.g., CSI report.

### [WTRU Determination of Precoder Type]

This section covers how the WTRU determines the precoder type.

### [[WTRU Determination Based on Preconfigured Conditions]]

This section covers how the WTRU determines the precoder type based on one or more of its measurements and the preconfigured conditions for determining the precoder type.

A WTRU may determine the precoder type to be indicated in PMI reporting using one or any combination of the following.

### [[[Conditions Based on Delay Spread]]]

In an embodiment, WTRU may determine the precoder type based on a measured delay spread value. For instance: WTRU may select a first precoder type, e.g., NF precoder, if delay spread is below a threshold; WTRU may select a second precoder type, e.g., hybrid NF-FF precoder, if delay spread is above a threshold.

In another embodiment, WTRU may determine the precoder type based on measured delay spread value (e.g., minimum, maximum, average delay spread, etc.) and/or WTRU detected region. For instance, WTRU may determine the precoder type based on WTRU detected region and a delay spread threshold associated with the detected region. For example:
WTRU may select a first precoder type, e.g., NF precoder, if WTRU detects a first region (e.g., inner focus region) and delay spread is below a threshold associated with the WTRU detected region;
WTRU may select a second precoder type, e.g., hybrid NF-FF precoder, if WTRU detects the first region and delay spread is above a threshold associated with the WTRU detected region;
WTRU may select a first precoder type, e.g., NF precoder, if WTRU detects a second region (e.g., outer focus region) and delay spread is below a threshold associated with the WTRU detected region;
WTRU may select a second precoder type, e.g., hybrid NF-FF precoder, if WTRU detects the second region and delay spread is above a threshold associated with the WTRU detected region.

### [[[Conditions Based on Detected NF Region]]]

In another example, WTRU may determine precoder type, e.g., NF precoder, hybrid NF-FF precoder, or FF precoder, based on the WTRU detected region. For instance:
WTRU may select a first precoder type, e.g., NF precoder, in case WTRU detects a first region, e.g., focus region, inner focus region;
WTRU may select a second precoder type, e.g., hybrid NF-FF precoder, in case WTRU detects a second region, e.g., focus region boundary, outer focus region;
WTRU may select a third precoder type, e.g., FF precoder, in case WTRU detects a third region, e.g., outside focus region.

A WTRU may be configured with association among different region types and different precoder types where:
a precoder type may be associated with more than one region;
a region type may be associated with more than one precoder type;

According to an embodiment, a WTRU may determine a region. Then, the WTRU may perform one or more measurements to determine the precoder type in case more than one precoder type are associated with the determined region.

A WTRU may be configured with an association among different region types and different depth of focus (e.g., spot beam sizes). For instance, a region type may be associated with one or more depth of focus values (spot beam sizes).

### [[[Conditions Based on WTRU Sensing of Surrounding Environment]]]

In one example, WTRU may determine the precoder type based on WTRU sensing of the surrounding environment. For instance:
WTRU may select a first precoder type, e.g., NF precoder, in case WTRU senses a first scattering profile, e.g., one or more nearby scatterers;
WTRU may select a second precoder type, e.g., hybrid NF-FF precoder, in case WTRU senses a second scattering profile, e.g., the WTRU does not sense any nearby scatterers.

### [[[WTRU Determination of an NF Precoder Type to be Used Based on Measurements and Configured Conditions]]]

### [[[Conditions Based on WTRU Sensing of Surrounding Environment]]]

In one example, WTRU may determine the NF precoder type based on WTRU sensing of surrounding environment. For instance:
WTRU may select a first NF precoder type, e.g., NF precoder with per FF beam beamfocusing parameter, in case WTRU senses one or more scatterers in inner focus region;
WTRU may select a second NF precoder type, e.g., NF precoder with per group of FF beams beamfocusing parameter” in case WTRU senses one or more scatterers located in same region, e.g., focus region boundary.

### [[[Conditions Based on WTRU Region Detection]]]

In yet another example, WTRU may determine the NF precoder type based on WTRU detected region. For instance:
WTRU may select a first precoder type (e.g., NF precoder with per-FF beam beamfocusing parameter, NF precoder with layer-independent beamfocusing parameters, NF precoder with phase calculation function based on second order Taylor series approximation, etc.) in case WTRU detects a first region, e.g., the inner focus region;
WTRU may select a second precoder type (e.g., NF precoder with per group of FF beams beamfocusing parameter, NF precoder with layer-dependent beamfocusing parameters, etc.) in case WTRU detects a second region, e.g., the focus region;
WTRU may select a third precoder type (e.g., NF precoder with a single beamfocusing parameter, NF precoder with layer-dependent beamfocusing parameters, NF precoder with phase calculation function based on first order Taylor series approximation, etc.) in case WTRU detects a third region, e.g., focus region boundary, outer focus region or outside focus region.

In yet another example, WTRU may determine the type of beamfocusing parameters (e.g., whether layer-dependent or layer-independent beamfocusing parameters) in an NF precoder based on the NF precoder type. For instance:
WTRU may select a first precoder type, e.g., NF precoder with layer-independent beamfocusing parameters, in case WTRU determines or is configured with a precoder type NF precoder with per FF beam beamfocusing parameter;
WTRU may select a second precoder type, e.g., NF precoder with layer-dependent beamfocusing parameters, in case WTRU determines or is configured with a precoder type NF precoder with per group of FF beams beamfocusing parameter;
WTRU may select a second precoder type, e.g., NF precoder with layer-dependent beamfocusing parameters, in case WTRU determines or is configured with a precoder type NF precoder with a single beamfocusing parameter.

In an embodiment, WTRU may determine a threshold that is indicated in precoder type determination based on a previous precoder type. For instance:
for a first precoder type (e.g., NF precoder), WTRU may determine to add a first configured hysteresis offset to a first configured threshold (e.g., delay spread threshold);
for a second precoder type (e.g., hybrid NF-FF precoder), WTRU may determine to subtract from a second configured threshold (e.g., delay spread threshold) a second configured hysteresis offset.

### [[WTRU Receives Indication of a Precoder Type]]

In response to a transmitted UL report including: one or more results of performed measurements for precoder type determination; and/or precoder type, a WTRU may receive one or any combination of the following.

In one example, the WTRU may receive indication from the network about the precoder type to be indicated in PMI reporting. For instance:
WTRU may receive a bitmap indicating the precoder type to be used from the one or more configured precoder types to the WTRU. Each bit in the bitmap is associated with a configured precoder type where a bit “0” indicates that the associated precoder type with the bit shall not be used while a bit “1” indicates that the associated precoder type with the bit shall be used;
WTRU may receive an index indicating the precoder type;
WTRU may receive a string variable indicating the precoder type.

In another example, the WTRU may receive acknowledgement/confirmation or negative-acknowledgement/rejection from the network about the determined and reported precoder type, e.g., a suggested or a recommended precoder type. For instance: WTRU may receive one bit indicating ACK/NACK (e.g., confirmation/rejection) of the determined and reported precoder type from WTRU to the NW. For instance, WTRU may receive a bit set to “1” to indicate acknowledgement (confirmation) of the determined and reported precoder type by WTRU while WTRU may receive a bit set to “0” to indicate negative-acknowledgement (rejection) of the determined and reported precoder type by WTRU.

### [Reporting of Determined Precoder Type]

In one embodiment, the WTRU may explicitly report the determined and/or selected precoder type for PMI reporting. For instance, the WTRU may report the determined precoder type through one of the following:
WTRU may send a bitmap indicating the determined precoder type from the one or more configured precoder types to the WTRU. Each bit in the bitmap is associated with a configured precoder type where a bit “O” indicates that the associated precoder type is not selected while a bit “1” indicates that the associated precoder type with the bit is selected;
WTRU may send an index indicating the determined/selected precoder type;
WTRU may send a string variable indicating the determined/selected precoder type.

The WTRU may send a report including determined precoder type, e.g., CSI report. In one example, the WTRU may report the determined precoder type jointly with the corresponding determined precoder attributes, e.g., the determined PMI based on the precoder type. In another example, the WTRU may report the determined precoder type in a separate report.

In another embodiment, the WTRU may implicitly indicate the determined precoder type through reporting the determined precoder attributes associated with the determined precoder type, e.g., in a CSI report.

### Further Exemplary Embodiments

According to an embodiment, WTRU determination of a precoder type is based on delay spread. In this example embodiment, a WTRU is configured with one or more conditions for determining the precoder type based on one or more WTRU measurements. The WTRU measures delay spread based on DL RS and selects a precoder type based on the measured delay spread.

In a first step, a WTRU may receive configurations (configuration information), which may include: one or more DL RS; multiple precoder types, e.g., a first, a second; and one or more conditions for determining precoder type based on WTRU measured delay spread, e.g., a threshold.

In a second step, the WTRU may measure its delay spread based on received DL RS.

In a third step, for a WTRU that is located in an NF region, the WTRU determines the precoder type for PMI reporting based on the measured delay spread and one or more configured conditions: the WTRU selects a first precoder type (e.g., NF precoder), based on measured delay spread; e.g., if measured delay spread is below a threshold; the WTRU selects a second precoder type (e.g., hybrid NF-FF precoder), e.g., if measured delay spread is above a threshold.

In a fourth step, the WTRU may perform one or any combination of the following: the WTRU determines precoder attributes based on the determined precoder type, and the WTRU may create a report including one or more of: the determined precoder type; the determined precoder attributes.

In a fifth step, the WTRU may send the report to the network, e.g., in PMI over PUCCH or PUSCH.

According to a further embodiment, WTRU determination of a precoder type is based on detected region. In this example embodiment, a WTRU is configured with one or more conditions for determining the precoder type based on one or more WTRU measurements. The WTRU performs RSRP measurements on one or more DL RS and determines the region wherein it operates based on the measured RSRPs. Then, WTRU selects the precoder type based on the detected region.

In a first step, the WTRU may receive configurations, which may include: one or more DL RS; multiple precoder types, e.g., a first and a second precoder type; and one or more conditions for determining the precoder type based on WTRU detected region.

In a second step, the WTRU may perform RSRP measurements on one or more received DL RS, and may determine its region (e.g., NF region) based on the RSRP measurements.

In a third step, the WTRU may determine the precoder type based on determined region and one or more configured conditions, e.g., the WTRU selects a first precoder type (e.g., an NF precoder type) if the WTRU determined that it is a first region, e.g., in the NF inner focus region; the WTRU selects a second precoder type (e.g., a hybrid NF-FF precoder type) if the WTRU determined that it is in a second region, e.g., in the NF outer focus region.

In a fourth step, the WTRU may perform one or any combination of the following: the WTRU may determine the precoder attributes based on the determined precoder type; the WTRU may create a report including one or more of the determined precoder type, and the determined precoder attributes.

In a fifth step, the WTRU may send the report to the network, e.g., in PMI over PUCCH or PUSCH.

In a further embodiment, a WTRU may be configured with one or more region-based delay spread thresholds. The WTRU measures delay spread based on a received DL RS and detects its region based on one or more RSRP measurements on one or more received DL RSs. Then, WTRU selects the precoder type based on the measured delay spread and a configured delay spread threshold for the detected region.

In a first step, the WTRU may receive configurations, which may include: one or more DL RS; multiple precoder types, e.g., a first and a second precoder type; one or more configured regions; one or more delay spread threshold; association between configured delay spread thresholds and configured regions; one or more conditions for determining the right/appropriate precoder based on WTRU detected region and measured delay spread.

In a second step, the WTRU may perform RSRP measurements on one or more received DL RS, and may determine the region in which it operates, based on the RSRP measurements.

In a third step, the WTRU may measure delay spread of the received DL RS.

In a fourth step, the WTRU may determine the precoder type based on the determined region, on the measured delay spread and on one or more configured conditions: the WTRU may select, from the configured multiple precoder types, a first precoder type (e.g., an NF precoder type) if measured delay spread is below a threshold associated with detected NF region; the WTRU may select, from the configured multiple precoder types, a second precoder (e.g., a hybrid NF-FF precoder type) if measured delay spread is above a threshold associated with detected NF region.

In a fifth step, the WTRU may perform one or any combination of the following: the WTRU may determine the precoder attributes based on the determined precoder type; the WTRU may create a report (e.g., a PMI report) including one or more of the determined precoder type, and the determined precoder attributes.

In a sixth step, the WTRU may send the report to the network, e.g. over PUCCH or PUSCH.

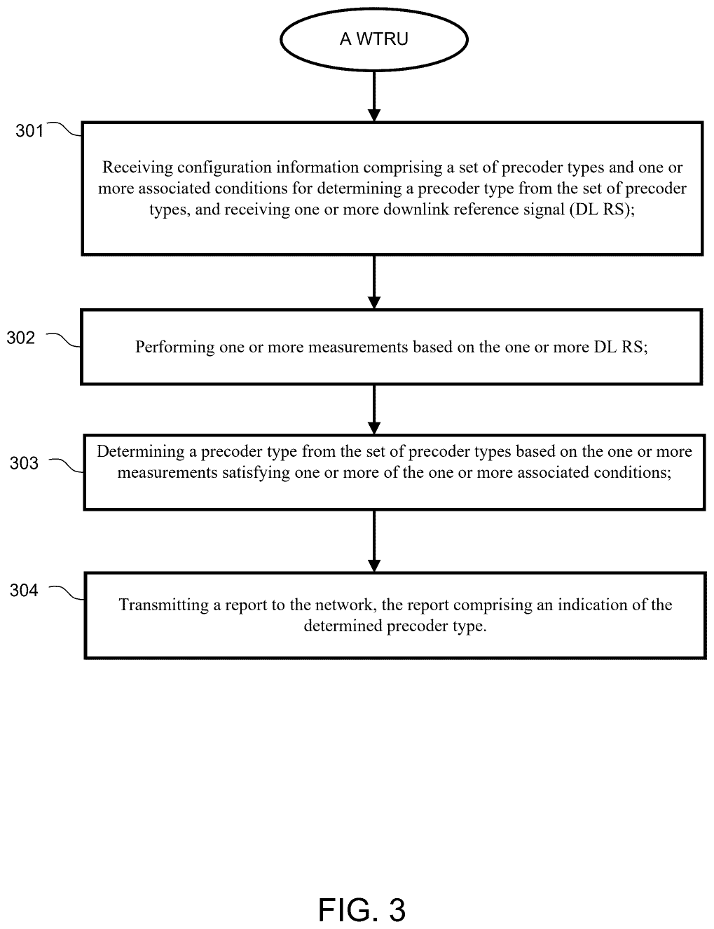

FIG. 3 is a flow chart of a method, implemented by a WTRU in a network, comprising:
receiving (301) configuration information comprising a set of precoder types and one or more associated conditions for determining a precoder type from the set of precoder types, and receiving one or more downlink reference signal (DL RS);
performing (302) one or more measurements based on the one or more DL RS;
determining (303) a precoder type from the set of precoder types based on the one or more measurements satisfying one or more of the one or more associated conditions; and
transmitting (304) a report to the network, the report comprising an indication of the determined precoder type.

According to an embodiment, the configuration information further comprises one or more associations among precoder types from the set of precoder types, and one or more ranges of delay spread values; performing the one or more measurements on the one or more DL RS comprises measuring delay spread of the one or more DL RS; and the determining of the precoder type from the set of precoder types based on the one or more measurements satisfying one or more of the one or more associated conditions comprises determining the precoder type from the set of precoder types based on the measured delay spread matching with a range of delay spread values of the one or more ranges of delay spread values.

According to an embodiment, the configuration information further comprises one or more associations among region types from a configured set of region types and precoder types from the set of precoder types; performing the one or more measurements on the one or more DL RS comprises determining a region type based on the one or more DL RS; and determining the precoder type from the set of precoder types based on the one or more measurements satisfying one or more of the one or more associated conditions comprises determining the precoder type from the set of precoder types for the determined region type.

According to an embodiment, the set of precoder types comprises any of: one or more near-field (NF) precoder types, one or more far-field (FF) precoder types, or one or more hybrid NF-FF precoder type.

According to an embodiment, the configured set of region types comprises any of: a near-field (NF) region type, an NF inner focus region type, an NF outer focus region type, and a far-field (FF) region type.

According to an embodiment, the configuration information further comprises one or more associations among region types from a configured set of region types, and one or more ranges of RSRP values; performing the one or more measurements based on the one or more DL RS comprises measuring RS received power (RSRP) of the one or more DL RS; determining a region type from the set of region types, based on the measured RSRP matching with a range of RSRP values of the one or more ranges of RSRP values; and determining the precoder type from the set of precoder types based on the one or more measurements satisfying one or more of the one or more associated conditions comprises determining the precoder type from the set of precoder types for the determined region type.

According to an embodiment, the configuration information further comprises one or more associations among region types from a configured set of region types, one or more ranges of delay spread values, and precoder types; performing one or more measurements based on the one or more DL RS comprises measuring delay spread of the one or more DL RS; determining a region type from the set of region types, based on the one or more DL RS; and determining the precoder type from the set of precoder types based on the one or more measurements satisfying one or more of the one or more associated conditions comprises determining the precoder type from the set of precoder types for the determined region type and from the measured delay spread matching with a range of delay spread values of the one or more ranges of delay spread values, according to the one or more associations.

According to an embodiment, the report is transmitted if (when, after) time elapsed, since a previous transmission of the report, is above a configured threshold.

According to an embodiment, the delay spread represents a difference between arrival times at the WTRU of an earliest and a latest multipath component of the one or more DL RS.

There is also disclosed and described a WTRU in a network, comprising at least one processor configured to:
receive configuration information comprising a set of precoder types and one or more associated conditions for determining a precoder type from the set of precoder types, and receive one or more downlink reference signal (DL RS); perform one or more measurements based on the one or more DL RS; determine a precoder type from the set of precoder types based on the one or more measurements satisfying one or more of the one or more associated conditions; and transmit a report to the network, the report comprising an indication of the determined precoder type.

According to an embodiment, the configuration information further comprises one or more associations among precoder types from the set of precoder types, and one or more ranges of delay spread values; perform the one or more measurements on the one or more DL RS comprises measuring delay spread of the one or more DL RS; and determine the precoder type from the set of precoder types based on the one or more measurements satisfying one or more of the one or more associated conditions comprises determine the precoder type from the set of precoder types based on the measured delay spread matching with a range of delay spread values of the one or more ranges of delay spread values.

According to an embodiment, the configuration information further comprises one or more associations among region types from a configured set of region types and precoder types from the set of precoder types; perform the one or more measurements on the one or more DL RS comprises determining a region type based on the one or more DL RS; and determine the precoder type from the set of precoder types based on the one or more measurements satisfying one or more of the one or more associated conditions comprises determine the precoder type from the set of precoder types for the determined region type.

According to an embodiment, the set of precoder types comprises any of: one or more near-field (NF) precoder types, one or more far-field (FF) precoder types, or one or more hybrid NF-FF precoder type.

According to an embodiment, the configured set of region types comprises any of: a near-field (NF) region type, an NF inner focus region type, an NF outer focus region type, and a far-field (FF) region type.

According to an embodiment, the configuration information further comprises one or more associations among region types from a configured set of region types, and one or more ranges of RSRP values; perform the one or more measurements based on the one or more DL RS comprises measuring RS received power (RSRP) of the one or more DL RS; the at least one processor is further configured to determine a region type from the set of region types, based on the measured RSRP matching with a range of RSRP values of the one or more ranges of RSRP values; and determine the precoder type from the set of precoder types based on the one or more measurements satisfying one or more of the one or more associated conditions comprises determine the precoder type from the set of precoder types for the determined region type.

According to an embodiment, the configuration information further comprises one or more associations among region types from a configured set of region types, one or more ranges of delay spread values, and precoder types; perform one or more measurements based on the one or more DL RS comprises measuring delay spread of the one or more DL RS; wherein the at least one processor is further configured to determine a region type from the set of region types, based on the one or more DL RS; and wherein determining the precoder type from the set of precoder types based on the one or more measurements satisfying one or more of the one or more associated conditions comprises determine the precoder type from the set of precoder types for the determined region type and from the measured delay spread matching with a range of delay spread values of the one or more ranges of delay spread values, according to the one or more associations.

According to an embodiment, the at least one processor is configured to transmit the report if time elapsed since a previous transmission of the report is above a configured threshold.

According to an embodiment, the delay spread represents a difference between arrival times at the WTRU of an earliest and a latest multipath component of the one or more DL RS.

The different embodiments described in the present document may be combined to form particularly advantageous embodiments. For all of the embodiments described, the network (e.g., the network node/gNB/TRP receiving the report, i.e., in the cell where the WTRU operates), may use the information comprised in the report (e.g., precoder type to use, precoder attributes to use) to adjust its DL transmissions to the WTRU, thereby optimizing reception by the WTRU of these transmissions. While the described embodiments may focus on NF region switching (e.g., between different NF regions) the embodiments may also be applied to NF-FF region switching, e.g., the WTRU may determine that it is in the FF region, and may report a precoder type appropriate for the FF region, and the WTRU may determine that it is in the NF region, and may report a precoder type appropriate for the NF region, where sub-NF regions may exist and may be reported, where each of the sub-NF regions—e.g., inner focus region, outer focus region—have an associated particular precoder type.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method, implemented by a wireless transmit-receive unit (WTRU) in a network, comprising:
receiving configuration information comprising a set of precoder types and one or more associated conditions for determining a precoder type from the set of precoder types, and receiving one or more downlink reference signal (DL RS);
performing one or more measurements based on the one or more DL RS;
determining a precoder type from the set of precoder types based on the one or more measurements satisfying one or more of the one or more associated conditions; and
transmitting a report to the network, the report comprising an indication of the determined precoder type.

2. The method according to claim 1, wherein:
the configuration information further comprises one or more associations among precoder types from the set of precoder types, and one or more ranges of delay spread values;
performing the one or more measurements on the one or more DL RS comprises measuring delay spread of the one or more DL RS; and
determining of the precoder type from the set of precoder types based on the one or more measurements satisfying one or more of the one or more associated conditions comprises determining the precoder type from the set of precoder types based on the measured delay spread matching with a range of delay spread values of the one or more ranges of delay spread values.

3. The method according to claim 1, wherein:
the configuration information further comprises one or more associations among region types from a configured set of region types and precoder types from the set of precoder types;
performing the one or more measurements on the one or more DL RS comprises determining a region type based on the one or more DL RS; and
determining the precoder type from the set of precoder types based on the one or more measurements satisfying one or more of the one or more associated conditions comprises determining the precoder type from the set of precoder types for the determined region type.

4. The method according to claim 1, wherein the set of precoder types comprises any of: one or more near-field (NF) precoder types, one or more far-field (FF) precoder types, or one or more hybrid NF-FF precoder type.

5. The method according to claim 3, wherein the configured set of region types comprises any of: a near-field (NF) region type, an NF inner focus region type, an NF outer focus region type, and a far-field (FF) region type.

6. The method according to claim 1, wherein:
the configuration information further comprises one or more associations among region types from a configured set of region types, and one or more ranges of RSRP values;
performing the one or more measurements based on the one or more DL RS comprises measuring RS received power (RSRP) of the one or more DL RS;
determining a region type from the set of region types, based on the measured RSRP matching with a range of RSRP values of the one or more ranges of RSRP values; and
determining the precoder type from the set of precoder types based on the one or more measurements satisfying one or more of the one or more associated conditions comprises determining the precoder type from the set of precoder types for the determined region type.

7. The method according to claim 1, wherein:
the configuration information further comprises one or more associations among region types from a configured set of region types, one or more ranges of delay spread values, and precoder types;
performing one or more measurements based on the one or more DL RS comprises measuring delay spread of the one or more DL RS;
determining a region type from the set of region types, based on the one or more DL RS; and
determining the precoder type from the set of precoder types based on the one or more measurements satisfying one or more of the one or more associated conditions comprises determining the precoder type from the set of precoder types for the determined region type and from the measured delay spread matching with a range of delay spread values of the one or more ranges of delay spread values, according to the one or more associations.

8. The method according to claim 1, wherein the report is transmitted if time elapsed since a previous transmission of the report is above a configured threshold.

9. The method according to claim 2, wherein the delay spread represents a difference between arrival times at the WTRU of an earliest and a latest multipath component of the one or more DL RS.

10. A wireless transmit-receive unit (WTRU) in a network, comprising at least one processor and configured to:
receive configuration information comprising a set of precoder types and one or more associated conditions for determining a precoder type from the set of precoder types, and receive one or more downlink reference signal (DL RS);
perform one or more measurements based on the one or more DL RS;
determine a precoder type from the set of precoder types based on the one or more measurements satisfying one or more of the one or more associated conditions; and
transmit a report to the network, the report comprising an indication of the determined precoder type.

11. The WTRU according to claim 10, wherein:
the configuration information further comprises one or more associations among precoder types from the set of precoder types, and one or more ranges of delay spread values;
perform the one or more measurements on the one or more DL RS comprises measuring delay spread of the one or more DL RS; and
being configured to determine the precoder type from the set of precoder types based on the one or more measurements satisfying one or more of the one or more associated conditions comprises being configured to determine the precoder type from the set of precoder types based on the measured delay spread matching with a range of delay spread values of the one or more ranges of delay spread values.

12. The WTRU according to claim 10, wherein:
the configuration information further comprises one or more associations among region types from a configured set of region types and precoder types from the set of precoder types;
perform the one or more measurements on the one or more DL RS comprises determining a region type based on the one or more DL RS; and
being configured to determine the precoder type from the set of precoder types based on the one or more measurements satisfying one or more of the one or more associated conditions comprises being configured to determine the precoder type from the set of precoder types for the determined region type.

13. The WTRU according to claim 10, wherein the set of precoder types comprises any of: one or more near-field (NF) precoder types, one or more far-field (FF) precoder types, or one or more hybrid NF-FF precoder type.

14. The WTRU according to claim 12, wherein the configured set of region types comprises any of: a near-field (NF) region type, an NF inner focus region type, an NF outer focus region type, and a far-field (FF) region type.

15. The WTRU according to claim 10,
wherein the configuration information further comprises one or more associations among region types from a configured set of region types, and one or more ranges of RSRP values;
wherein being configured to perform the one or more measurements based on the one or more DL RS comprises being configured to measure RS received power (RSRP) of the one or more DL RS;
further configured to determine a region type from the set of region types, based on the measured RSRP matching with a range of RSRP values of the one or more ranges of RSRP values; and
wherein being configured to determine the precoder type from the set of precoder types based on the one or more measurements satisfying one or more of the one or more associated conditions comprises being configured to determine the precoder type from the set of precoder types for the determined region type.

16. The WTRU according to claim 10,
wherein the configuration information further comprises one or more associations among region types from a configured set of region types, one or more ranges of delay spread values, and precoder types;
wherein being configured to perform one or more measurements based on the one or more DL RS comprises being configured to measure delay spread of the one or more DL RS;
further configured to determine a region type from the set of region types, based on the one or more DL RS; and
wherein being configured to determine the precoder type from the set of precoder types based on the one or more measurements satisfying one or more of the one or more associated conditions comprises being configured to determine the precoder type from the set of precoder types for the determined region type and from the measured delay spread matching with a range of delay spread values of the one or more ranges of delay spread values, according to the one or more associations.

17. The WTRU according to claim 10, configured to transmit the report if time elapsed since a previous transmission of the report is above a configured threshold.

18. The WTRU according to claim 11, wherein the delay spread represents a difference between arrival times at the WTRU of an earliest and a latest multipath component of the one or more DL RS.
